(19) United States
(12) Patent Application Publication
(10) Pub. No.: US 2021/0316675 A1
(43) Pub. Date: Oct. 14, 2021

(54) METHOD AND DEVICE FOR FITTING A LICENSE PLATE, PREFERABLY A MOTOR VEHICLE LICENSE PLATE, WITH A DATA CARRIER, AND LICENSE PLATE

(71) Applicant: Tönnjes ISI Patent Holding GmbH, Delmenhorst (DE)

(72) Inventors: Björn Beenken, Ganderkesee (DE); Piet Tönjes, Delmenhorst (DE)

(73) Assignee: Tönnjes ISI Patent Holding GmbH, Delmenhorst (DE)

(21) Appl. No.: 17/251,925

(22) PCT Filed: Jun. 13, 2019
(86) PCT No.: PCT/EP2019/065566

§ 371 Date: Dec. 14, 2020

(30) Foreign Application Priority Data
Jun. 15, 2018 (DE) 10 2018 004 756.4
Sep. 25, 2018 (DE) 10 2018 007 540.1

(51) Int. Cl. B60R 13/10; G09F 13/16; G09F 3/02; G09F 21/04; G06K 19/077

(52) U.S. Cl. CPC B60R 13/105; G09F 13/16; G09F 3/02; G09F 2007/1895; G06K 19/07786; G09F 2003/023; G09F 21/04

(57) ABSTRACT

A method and a device with which a license plate can be produced in a favorable fashion. This is achieved by assigning a sticker to a license plate body of the license plate or to a metal plate in order to produce a multiplicity of license plate bodies. Very precise positioning of a data carrier in a receptacle of a license plate body of a license plate is particularly costly. Increased fabrication costs are to be expected owing to the necessary precision and the associated complexity of the production process of a license plate having a data carrier.

### CROSS REFERENCE TO RELATED APPLICATIONS

This application is the US National Phase of and claims the benefit of and priority on International Application No. PCT/EP2019/065566 having an international filing date of 13 Jun. 2019, which claims priority on and the benefit of German Patent Application No. 10 2018 004 756.4 having a filing date of 15 Jun. 2018 and German Patent Application No. 10 2018 007 540.1 having a filing date of 25 Sep. 2018.

### BACKGROUND OF THE INVENTION

### Technical Field

The invention relates to a method for equipping a license plate, preferably a motor vehicle license plate, with at least one data carrier which can be read out in a contactless fashion, wherein the data carrier is secured to the license plate. Furthermore, the invention relates to a device for equipping a license plate, preferably a motor vehicle license plate, with at least one data carrier which can be read out in a contactless fashion and which is integrated into a sticker, in particular a label, with a plurality of successive workstations which are linked to at least one conveyor, and is designed to carry out a method as disclosed herein. Furthermore, the invention relates to a license plate, in particular to a motor vehicle license plate, having a license plate body which has at least one inscription field, and having at least one inscription which is assigned to the inscription field of the license plate body, wherein at least one transponder which can be read out in a contactless fashion and has a data carrier and an antenna for communication is assigned to the license plate body, and wherein the license plate body is covered with a protective cover.

### Prior Art

License plates, specifically in particular motor vehicle license plates, are increasingly equipped with data carriers which can be read out in a contactless fashion and can preferably also be written to in a contactless fashion. In this context, the data carriers are to be positioned precisely on or in a position or receptacle which is provided for this purpose in a license plate body of the license plate so that they operate, in particular can be read out, in an interference-free fashion. Particularly the very precise positioning and the possibly necessary very precise casting of a data carrier into a receptacle of the license plate body are particularly costly in terms of processing technology. Increased fabrication costs are to be expected owing to the high necessary precision and the associated complexity of the production process of a license plate having a data carrier.

### BRIEF SUMMARY OF THE INVENTION

The invention is based on the object of providing a method and a device with which a license plate can be produced in a favorable fashion.

A method for achieving this object is a method for equipping a license plate, preferably a motor vehicle license plate, with at least one data carrier which can be read out in a contactless fashion, wherein the data carrier is secured to the license plate, characterized in that at least one sticker, in particular a label, which has the at least one data carrier, is secured to the license plate body or to a metal plate in order to produce a multiplicity of license plate bodies. Accordingly, there is provision that a sticker, which can also be referred to as a label, is assigned to a license plate body of the license plate or to a metal plate in order to produce a multiplicity of license plate bodies. This sticker may be a flat, preferably flexible, lamella in which a data carrier is integrated. Moreover, a communication means, such as for example an antenna, in the sticker can be assigned to the data carrier. For example, information relating to the use of the license plate and information about a motor vehicle or the owner of the motor vehicle can be stored on the data carrier. Furthermore, it is conceivable that further information is also stored on the data carrier. The information which is stored on the data carrier in the sticker can both be read out and newly written to in a contactless fashion. Such a sticker can be handled particularly easily. It can be applied as desired to the license plate body or the metal plate. Owing to ease of handling the sticker, the production method and the equipping of the license plate with the data carrier prove particularly cost-effective.

Long metal plates or metal strips, preferably composed of aluminum or steel, are used as the starting product for the production of license plates. The license plate bodies are punched out of these “infinitely” long metal plates in the production method of the license plate. However, according to the invention it is provided that before the punching out of the license plate bodies from the metal plate, the stickers are applied or secured to the metal plate. The securement can be carried out by means of a suitable active substance.

An exemplary embodiment of the invention can provide that the sticker which is preferably embodied in a self-adhesive fashion is secured or stuck to a front side of the license plate. Similarly, it is, of course, also conceivable that the sticker is stuck to a front side of the metal plate, specifically before the license plate is punched out of the metal plate. Furthermore, there can be provision that the sticker is stuck to the front side of the license plate body or to a film which is applied to the front side of the license plate body. In the event that the sticker is firstly stuck to the metal plate or the license plate body, and the metal plate or the license plate body is only subsequently equipped with the film, which may be, for example, a self-adhesive reflective film, the sticker is incorporated in the license plate. In this incorporated state, the sticker is virtually invisible from the outside and can only be removed from the license plate body by destruction. Such a way of equipping the license plate with a data carrier therefore provides, on the one hand, a favorable production method and, on the other hand, increased protection against tampering. In the exemplary embodiment, in which the sticker is stuck to the film which is already applied to the metal plate or to the license plate body, the costs for production can be reduced even further.

A further exemplary embodiment can provide that the sticker which is preferably embodied in a self-adhesive fashion is secured or stuck to a rear side of the license plate. Similarly, it is, of course, also conceivable that the sticker is stuck to a rear side of the metal plate, specifically before the license plate is punched out of the metal plate. In particular, the application of the sticker to the rear side of the license plate body or the metal plate provides increased protection against environmental influences or vandalism. Furthermore, there can be provision that the sticker is stuck to the rear side of the license plate body or to a film which is applied to the rear side of the license plate body. In the event that the sticker is firstly stuck to the metal plate or the license plate body and the metal plate or the license plate body is only subsequently equipped with the film, which may be, for example, a self-adhesive reflective film, the sticker is incorporated in the license plate. In this incorporated state, the sticker is virtually invisible from the outside and can only be removed from the license plate body by destruction. Such a way of equipping the license plate with a data carrier therefore provides, on the one hand, a favorable production method and, on the other hand, increased protection against tampering. In the exemplary embodiment in which the sticker is stuck to the film which is already applied to the metal plate or to the license plate body, the costs for production can be reduced even further.

Moreover, it can also be provided that the at least one sticker, preferably a multiplicity of stickers, is applied to the metal plate, wherein the stickers are applied spaced apart from one another to the metal plate, and the distance between adjacent stickers corresponds to the one dimension, preferably at least approximately to a length, of the license plate body. In this context, the individual stickers are secured or stuck in an automated fashion, spaced apart from one another, to the elongate metal plate. In this context, the metal plate can be transported through under an application device for the stickers. The stickers are positioned on the metal plate in such a way that the positions of the stickers are the same for all the license plate bodies which are punched out later. The distance between the individual stickers is therefore determined by the shape and the dimensions of the license plate body or of the license plate.

If the individual stickers are firstly secured to the metal plate or the license plate body, the stickers can subsequently be secured to the metal plate or the license plate body by the film or the self-adhesive reflective film. After the metal plate has been transported through under the application device for the stickers and equipped with stickers, the film is applied or stuck to the metal plate, preferably under mechanical stress. This combination of the metal plate with the film causes the sticker to be enclosed between the plate and the film and additionally secured in its position.

A further exemplary embodiment can preferably provide that the at least one sticker having the data carrier is applied to a film which is embodied in a self-adhesive fashion, and this film having the stickers is stuck to the metal plate or to a license plate body. There can be provision here that the film is already equipped with a multiplicity of stickers which are arranged at a constant distance from one another. As a result of the fact that the film is self-adhesive, the stickers are secured on the adhesive side, in particular the rear side, of the film. As a result of this advanced positioning of the stickers on the film, further orientation of the stickers on the metal plate or the license plate body becomes superfluous. All that has to be ensured is that the film is applied or stuck to the metal plate congruently and preferably under stress. As a result of this bonding of the film, the individual stickers are automatically secured at the provided position on the metal plate or the license plate body.

In particular there can also be provision that before the application of the at least one sticker or of the film having at least one sticker, a cutout, if appropriate a slot, in particular a multiplicity of slots, is punched into the metal plate. This cutout or these slots can be used as slot antennas for the communication of the transponder which is integrated in the sticker.

There can also be provision that the slot antenna functions as an amplifier for the antenna which is already integrated in the sticker. For the application of the stickers or of the film with the stickers to the metal plate with the slots, the metal plate is to be clocked in such a way that the stickers or the film with the stickers is applied at a position which can be predetermined on the license plate body.

There can be provision that the sticker is positioned over the slot at least in certain areas. A particular exemplary embodiment provides that the sticker is arranged centrally on the slot or at an edge region of the slot. By virtue of this positioning, the transponder or the antenna which is arranged in the sticker can be coupled particularly efficiently to the slot antenna and therefore ensure particularly reliable communication. Similarly, for the positioning of the film with the sticker on the slotted metal plate the film is to be clocked so that the film is coordinated with the plate for their application to one another.

There can preferably also be provision that the license plate body of the license plate or of the motor vehicle license plate is punched out of the metal plate having the film with the at least one sticker, specifically in such a way that each license plate body has at least one sticker and a slot. The blank which is produced in this way for a license plate can then be provided with corresponding alphanumerics, specifically by stamping or printing or the like. The slot in the license plate body can be filled with a casting compound before this further stamping or after it, in order to protect the license plate against environmental influences. Filling of the slot advantageously occurs from the rear side of the license plate body. The casting compound can for this purpose be filled into the slot by means of a spray device and can be subjected to thermal energy, in particular UV radiation, for more rapid curing.

A license plate for achieving the object specified at the beginning is a license plate, in particular motor vehicle license plate, having a license plate body which has at least one inscription field, and having at least one inscription which is assigned to the inscription field of the license plate body, wherein at least one transponder which can be read out in a contactless fashion and has a data carrier and an antenna for communication is assigned to the license plate body, and wherein the license plate body is covered with a protective cover, characterized in that the transponder is integrated into a sticker, in particular a label, and the sticker can be secured to the license plate. Accordingly, the license plate according to the invention has a license plate body with at least one inscription field to which an inscription is assigned. Furthermore, a transponder which can be read out in a contactless fashion, for the purpose of communication, is assigned in the license plate body. The transponder contains a data carrier and an antenna. The license plate body is also covered with a protective cover which is preferably embodied as a film. The abovementioned transponder is integrated in a sticker or label, and this sticker can be secured to the license plate. The sticker is preferably a lamella-like, weatherproof enclosure or sheath around the transponder. As a result of the fact that the sticker can easily be secured to the license plate, the complexity of previous production methods for equipping a license plate with a data carrier is reduced.

There can preferably also be provision that the sticker is embodied in a self-adhesive fashion and can be stuck to the license plate body or the protective cover, in particular of a reflective film, or can be incorporated into the license plate. In this context, the lamella-like sticker can be embodied in a self-adhesive fashion only on one side or on both sides. The adhesive connection between the sticker and the license plate body or the protective cover is embodied in such a way that if an attempt is made to remove the sticker from the license plate body the sticker and therefore the data carrier or the transponder is destroyed. In addition, there may be provision for this purpose that the sticker has predetermined break points or predetermined tear points. This adhesive connection can therefore improve the protection of the license plate against tampering.

A further exemplary embodiment can provide that the transponder which is integrated into the sticker is embodied as an NFC transponder. NFC transponders are suitable, in particular, for near-field communication. The license plate which is claimed here, together with the sticker, could therefore be easily read out by means of a hand-held reading device or a cellphone. This provides an advantage, in particular, for the checking of license plates, by security services for example.

Moreover, there can be provision according to the invention that the license plate body has a UHF antenna which is formed by a slot, and the sticker can be assigned to this UHF antenna, wherein the transponder is embodied as an RFID chip which is coupled to the UHF antenna. The dimensioning of the slot and the positioning of the sticker in relation to the slot depend on the dimensioning of the license plate and on the necessary amplification. The sticker with the RFID chip is preferably to be combined with the slot only in certain areas. Information can be read out even over a relatively large distance through inductive or capacitive coupling of the RFID chip to the UHF antenna or the slot. As a result of the fact that the RFID chip together with the sticker is to be attached over the slot with a certain tolerance, the expenditure in terms of processing technology with regards to precise positioning of an RFID chip in a receptacle can be reduced greatly and costs can therefore be reduced.

In addition to the NFC transponders and the RFID chips described above, the transponder can also comprise active electronic components. For this purpose, there can be provision that a battery, in particular a button cell, is additionally arranged as an energy supply in the sticker. Similarly, there may be provision that the energy for the operation of the active component is drawn from another source, such as for example a photo cell or the like.

Moreover, there may be provision for the license plate according to the invention that the protective cover on the license plate body is at least partially demetallized, at least in certain areas. In this context, in particular the area in which the sticker and/or the slot is located is to be demetallized. Without the demetallization, the metal particles in the protective cover could reduce the transmission performance or reception performance of the transponders or of the RFID chip. As a result of the demetallization, the performance of the transponder or of the chip is not adversely affected. Furthermore, it is conceivable that the protective cover is embodied prismatically or as a prismatic film or as a PVC film or as a transparent plate, in particular made of PMMA or PC, or as some other type of film.

A device for achieving the abovementioned object is a device for equipping a license plate, preferably a motor vehicle license plate, with at least one data carrier which can be read out in a contactless fashion and which is integrated into a sticker, in particular a label, with a plurality of successive workstations which are linked to at least one conveyor, and is designed to carry out a method as disclosed herein. Accordingly, a plurality of successive workstations are provided which are linked to one another with a conveyor in each case. The successive workstations serve to carry out the method steps described here.

### BRIEF DESCRIPTION OF THE DRAWINGS

Preferred exemplary embodiments of the invention are explained in more detail below with reference to the drawing, in which:

FIG. 1a shows an illustration of a section of a metal plate;

FIG. 1b shows a metal plate according to FIG. 1a with applied stickers;

FIG. 1c shows a metal plate according to FIG. 1b with an applied film;

FIG. 1d shows an illustration of a license plate which is punched out of the metal plate;

FIG. 2a shows an illustration of a section of a metal plate;

FIG. 2b shows an illustration of a section of a film with applied stickers;

FIG. 2c shows an illustration of the film according to FIG. 2b applied to the metal plate;

FIG. 2d shows an illustration of the license plates punched out of the metal plate;

FIG. 3a shows an illustration of a metal plate with slots;

FIG. 3b shows an illustration with stickers applied to the slots;

FIG. 3c shows an illustration of the metal plate according to FIG. 3b with an applied film;

FIG. 3d shows an illustration of license plates punched out of the metal plate;

FIG. 4a shows an illustration of a section of a metal plate with slots;

FIG. 4b shows an illustration of a film section with applied stickers;

FIG. 4c shows an illustration of the metal plate according to FIG. 4a with the applied film from FIG. 4b;

FIG. 4d shows an illustration of the license plates punched out of the metal plate;

FIG. 5 shows an illustration of a completed license plate with alphanumerics stamped on; and

FIG. 6 shows an illustration of a completed license plate with alphanumerics stamped on.

### DETAILED DESCRIPTION OF PREFERRED EMBODIMENTS

Exemplary embodiments of the method according to the invention and of the license plate according to the invention are illustrated below with reference to the figures of the drawing. However, the invention is not limited to the illustrated exemplary embodiments or to the illustrated and described features and measures. There is also no provision of a limitation of the invention to individual features illustrated in the figures. It is therefore conceivable according to the invention that features or measures of the different exemplary embodiments which are illustrated here by way of example can be combined without limitation, or individual features from the exemplary embodiments can be omitted. In addition to the exemplary embodiments illustrated here, a multiplicity of further measures and features on which the same inventive concept is based are also conceivable.

A metal plate 10 is present as a starting material or starting situation for the method for equipping a license plate with a data carrier. This metal plate 10 is fed as a strip-like “continuous material” to a first workstation. This metal plate 10 can be produced from aluminum, steel or the like. However, it is also conceivable that a plastic, such as for example PMMA, is used as the starting material.

This metal plate 10 is fed with a virtually straight orientation to an application device or labelling device, by which stickers 11 which are spaced apart from one another are applied to a front side 12 of the metal plate 10. These stickers 11 are enclosed or sheathed or housed data carriers with a communication means. The sticker 11 is embodied in such a way that it is weatherproof. Furthermore, it has an adhesive layer on at least one side, so that the self-adhesive sticker 11 can be applied to the front side 12 of the metal plate without the front side 12 having to be firstly provided with a corresponding adhesive.

The communication means of the data carrier may be, for example, an RFID chip or some other transponder such as, for example, an NFC transponder. Depending on the design, the communication device can have an antenna which is suitable for communication in various frequency bands. Data stored on the data carrier can be read out via this communication device. Furthermore, there may be provision that the data carrier can be written to via this communication device.

The application device (not illustrated) for the stickers 11 applies the stickers 11 at an equal distance. This can be achieved by moving the metal plate 10 forward at a constant speed or with a constantly clocked progression in a fabrication direction 13. An exemplary embodiment can provide that the metal plate 10 is clocked so that the individual fabrication stations detect the positions at which, for example, the stickers 11 are to be positioned. Such clocking of the metal plate 10 or else of the applied stickers 11 makes it possible to dispense with actively reading out specific license plates in order to determine an application location, for example of the stickers 11.

A further exemplary embodiment (not illustrated) can provide that the stickers 11 are applied to a rear side of the metal plate 10 in the same way as described above.

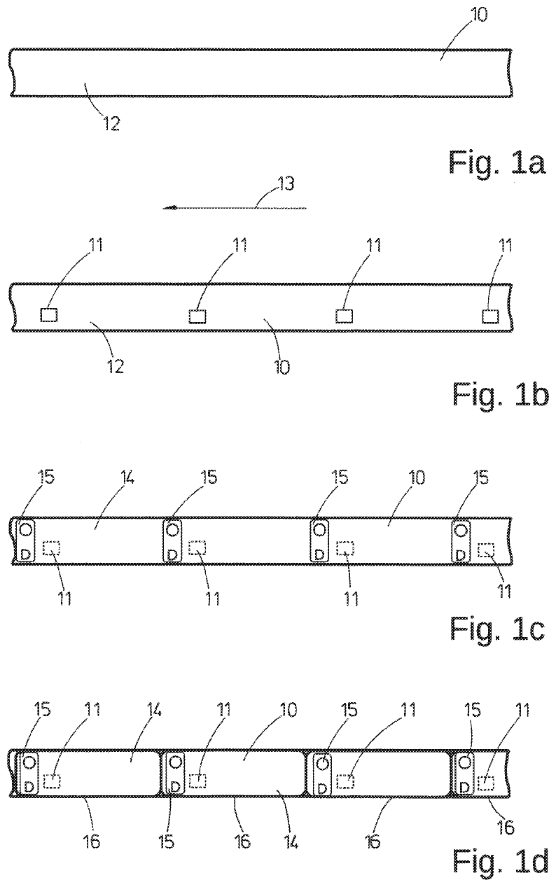

The metal plate 10 which is applied with the stickers 11 in FIG. 1b is then conveyed, by means of a conveyor device (not illustrated), to a further workstation (not illustrated), which in turn occurs with an incremental movement.

In the next workstation, a film 14 is applied to the front side 12 of the metal plate 10. This preferably self-adhesive film 14 is placed on the metal plate 10 as a function of the clocking. This can occur with a certain degree of prestress so that no undesired bubbles or the like form between the film and the metal plate 10. The film 14 may be a reflective film with a field 15 for the German Federal State, as illustrated in FIG. 1c. Similarly, there can also be provision that the film 14 has a different marking or an image. The stickers 11 which have been previously applied are covered by the film 14 so that, if appropriate, only a contour of the stickers 11 can still be seen under the film 14.

In the exemplary embodiment illustrated by FIG. 1a to FIG. 1d, the positioning accuracy of the stickers 11 or of the film 14 is not essential. The positioning tolerance with which the stickers 11 can be applied to the metal plate 10 is relatively large, resulting in the expenditure on processing technology for positioning being low and therefore more favorable.

There can be provision that the film 14 is metallized. This metallization can be demetallized in certain areas at the positions at which the sticker 11 is located. Such demetallization is to be borne in mind for the transmission and reception of electromagnetic waves by the communication unit. Coverage of the stickers 11 by a metallized film could give rise to a limited performance of the communication module.

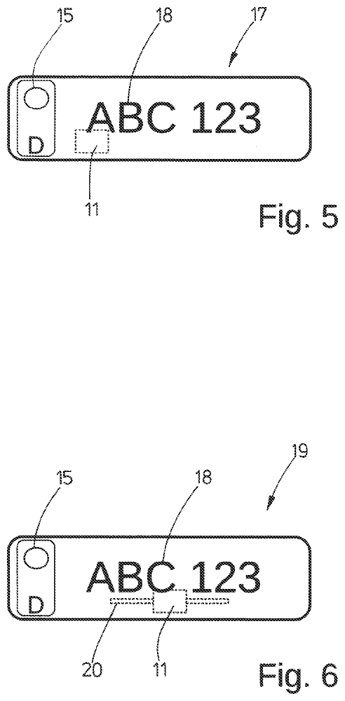

The metal plate 10 having the film 14 is transported in time cycles to a subsequent workstation (not illustrated) by a further conveying means. Clocking of the metal plate 10 also occurs here, so that the individual license plate bodies 16 can be punched out of it. The clocking or the punching occurs in such a way that the film 14 with the field 15 for the German Federal State and the sticker 11 underneath it are respectively located at the predetermined position on the front side 12 of the license plate bodies. In this workstation, a multiplicity of license plates 17 is punched out of the “infinite” metal plate 10, with a license plate body 16 which has the film 14 and the sticker 11. The individual license plates 17 are then fed individually to a stamping device. In this process step, the license plates 17 are personalized by means of a stamping process and a subsequent hot stamping process. For this, the license plates 17 from the preceding process step are packed and sent to a local approval body. The desired or required alphanumerics 18 and a frame of the license plate 17 are stamped in a stamping press. Depending on the stamping method, the frame is firstly stamped on and then the alphanumerics (FIG. 5). In order to produce a better contrast between the underlying surface, that is to say the film 14, and the stamped alphanumerics 18, the stamped areas are colored in by a hot stamping process. Black hot stamping films are frequently used for this.

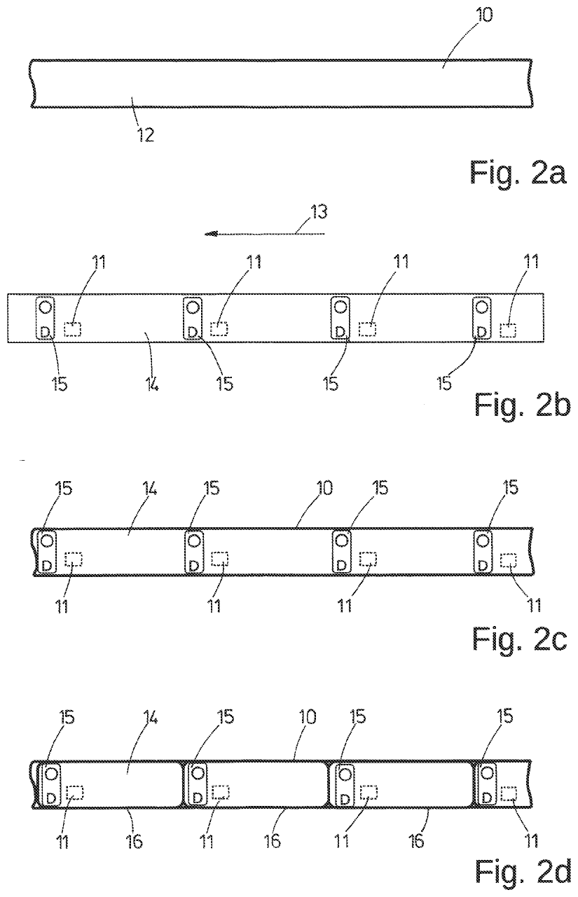

In a further exemplary embodiment of the invention which is illustrated by FIGS. 2a to 2d, the film 14 already has the stickers 11 before it is applied to the metal plate 10. Since the individual elements of the second exemplary embodiment are identical to the exemplary embodiment in FIGS. 1a to 1d, the same reference numbers are used.

There can be provision that the film 14 or the reflective film is already supplied with pre-applied stickers 11 by the film supplier, or a corresponding device applies the stickers 11 to a rear side of the film 14 before the application of the film 14 to the front side 12 of the metal plate 10. Since the film 14 is embodied in a self-adhesive fashion, the sticker 11 can be applied to the rear side in a simple way.

In a further process step (illustrated in FIG. 2c), the film 14 is then applied to the front side 12 of the metal plate 10. It is not necessary to clock the metal plate 10 here. Clocking occurs only after the application of the film 14 to the metal plate 10, so that in the following process step illustrated in FIG. 2d the individual license plate bodies 16 can be punched out of the metal plate 10 again. This punching process must in turn take place in such a way that each license plate body 16 has the field 15 for the German Federal State at a predefined position. The steps following the punching process step are identical to those of the exemplary embodiment described above.

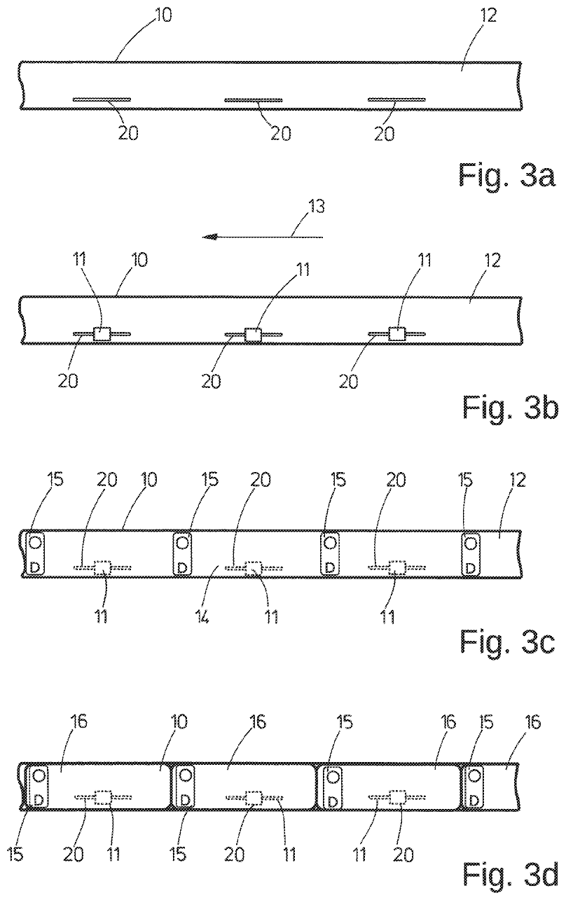

In a further exemplary embodiment (illustrated by means of FIGS. 3a to 3d), the completed license plates 19 have a slot antenna which functions as an antenna or as an amplification means for the communication unit, which is integrated into the sticker 11, of the data carrier. The slot antenna is formed by a slot 20 which is punched into the metal plate 10 right at the beginning of the production method (FIG. 3a). The punching of the metal plate 10 in turn occurs in a clocked fashion. By virtue of incremental transportation of the metal plate 10 in the fabrication direction 13, the metal plate 10 is always conveyed under a punching device (not illustrated) for the slots 20 in just such a way that the slots 20 always assume the same position on the metal plate and are equally spaced apart from one another.

In a following fabrication step, in a further workstation in each case a sticker 11 is positioned or applied over the slots 20 at least in certain areas. By virtue of the clocking of the metal plate 10 on the basis of the slots 20, the metal plate 10 is conveyed with clocking in just such a way that the labelling machine can apply the stickers 11 at a predetermined position over the slots 20 (FIG. 3b). The section illustrated in FIG. 3b with the applied stickers 11 is then moved on incrementally into a subsequent workstation for the application of the film 14. During this time, there is then continuous punching of further slots 20 and subsequent application of further stickers 11 to the slots 20, so that a continuous production process of the license plates 19 results.

The film 14 is applied to the front side 12 of the metal plate 10 as a function of the clocking. As in the other exemplary embodiments, the film 14 is also embodied in a self-adhesive fashion here and is applied to the metal plate with slight prestress.

Finally, as already illustrated by FIGS. 1d and 2d, in a further step the individual license plate bodies 16 are punched out of the metal plate 10 (FIG. 3d).

After the individualization of the license plates 19, a rear side of the license plate body 16 is processed. On the rear side of the license plate body 16, a casting compound is filled into the region of the slot antenna or of the slots 20 with a casting system. The casting compound is, on the one hand, intended to prevent the ingress of foreign particles and moisture and therefore to ensure the functioning of the license plate 19, and, on the other hand, is intended to protect the sticker against mechanical influences or tampering (FIG. 6). The casting compound which is used may be, for example, UV-curing, for which reason the casting compound can be illuminated with a UV radiator in this process step. The individual license plates 19 or the license plate blanks are completed after this curing of the casting compound. A further exemplary embodiment of the invention in this context could be to apply the sticker for covering the slot 20 to the rear side of the license plate body 16.

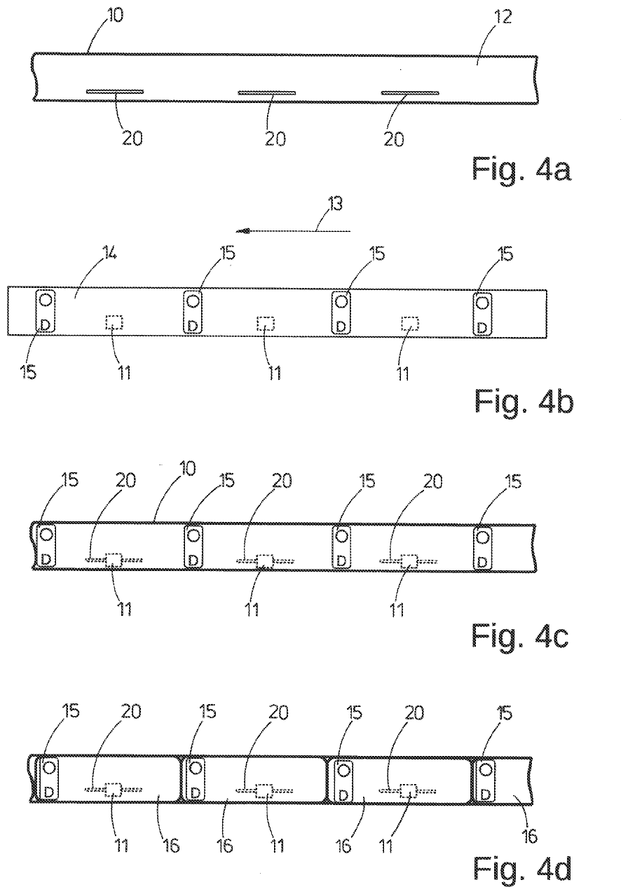

Finally, FIGS. 4a to 4d describe a further exemplary embodiment of a method for producing a license plate 19. In the exemplary embodiment illustrated there by way of example, a film 14 with stickers 11 already applied to the rear side of the film 14, similarly to FIGS. 2a to 2d, is described (FIG. 4b). This film 14 is applied to the metal plate 10 having the slots 20, specifically in such a way that the stickers 11 are positioned over the slots 20 at least in certain areas. This is done by clocking the progression of the metal plate 10 and synchronizing this clocking with the position of the stickers 11 or of the fields 15 for German Federal States on the film 14. The other method steps behave identically to those in the preceding exemplary embodiments.

### LIST OF REFERENCE NUMBERS

10 Metal plate
11 Sticker
12 Front side
13 Fabrication direction
14 Film
15 Field for German Federal States
16 License plate body
17 License plate
18 Alphanumerics
19 License plate
20 Slot

1. A method for equipping a license plate (17, 19), preferably a motor vehicle license plate, with at least one data carrier which can be read out in a contactless fashion, wherein the data carrier is secured to the license plate (17, 19), wherein at least one sticker (11), in particular a label, which has the at least one data carrier, is secured to a license plate body (16) or to a metal plate (10) in order to produce a multiplicity of license plate bodies (16).

2. The method as claimed in claim 1, wherein at least one transponder with a data carrier and at least one antenna are integrated into the sticker (11).

3. The method as claimed in claim 1, wherein the sticker (11) which is preferably embodied in a self-adhesive fashion is stuck to a front side (12) of the license plate (17, 19), in particular to a front side (12) of a license plate body (16) of the license plate (17, 19), or to a film (14) which is applied to the front side (12) of the license plate body (16).

4. The method as claimed in claim 1, wherein the sticker (11) which is preferably embodied in a self-adhesive fashion is stuck to a rear side of the license plate (17, 19), in particular to a rear side of a license plate body (16) of the license plate (17, 19), or to a film which is applied to the rear side of the license plate body (16).

5. The method as claimed in claim 1, wherein the at least one sticker (11), preferably a multiplicity of stickers (11), is applied to the metal plate (10), wherein the stickers (11) are applied spaced apart from one another to the metal plate (10), and the distance between adjacent stickers (11) corresponds to the one dimension, preferably at least approximately to a length, of the license plate body (16).

6. The method as claimed in claim 1, wherein the at least one sticker (11) is secured to the metal plate (10) or the license plate body (16) by a film (14), in particular a self-adhesive reflective film.

7. The method as claimed in claim 1, wherein the at least one sticker (11), preferably a multiplicity of stickers (11), having the data carrier is applied to a film (14), in particular a reflective film, which is embodied in a self-adhesive fashion, and the film (14) is stuck, together with the at least one sticker (11), to the metal plate (10) or the license plate body (16).

8. The method as claimed in claim 7, wherein before the application of the at least one sticker (11) or of the film (14) having at least one sticker (11), a cutout, preferably a slot (20), in particular a multiplicity of slots (20), is punched into the metal plate (10).

9. The method as claimed in claim 7, wherein the at least one sticker (11) or the film (14) with the at least one sticker (11) is arranged on the metal plate (10) in such a way that a sticker (11) is respectively arranged over a slot (20) at least in certain areas.

10. The method as claimed in claim 7, wherein the license plate body (16) which forms the license plate (17, 19), preferably the motor vehicle license plate, with a respective sticker (11) and, if appropriate, a respective slot (20), is punched out of the metal plate (10) having the film (14) with the at least one sticker (11).

11. The method as claimed in claim 10, wherein the cutout, in particular the slot (20), is filled with a casting compound from a rear side of the license plate body (16).

12. The method as claimed in claim 1, wherein alphanumerics (18) are applied, preferably stamped or printed, onto the license plate (17, 19).

13. A license plate (17, 19), in particular motor vehicle license plate, having a license plate body (16) which has at least one inscription field, and having at least one inscription which is assigned to the inscription field of the license plate body (16), wherein at least one transponder which can be read out in a contactless fashion and has a data carrier and an antenna for communication is assigned to the license plate body (16), and wherein the license plate body (16) is covered with a protective cover, wherein the transponder is integrated into a sticker (11), in particular a label, and the sticker (11) can be secured to the license plate (17, 19).

14. The license plate (17, 19) as claimed in claim 13, wherein the sticker (11) is embodied in a self-adhesive fashion and can be stuck to the license plate body (16) or the protective cover, in particular a film (14) or reflective film, or can be incorporated into the license plate (17, 19).

15. The license plate (17, 19) as claimed in claim 13, wherein the transponder which is integrated into the sticker (11) is embodied as an NFC transponder.

16. The license plate (17, 19) as claimed in claim 13, wherein the license plate body (16) has a UHF antenna which is formed by a slot (20), and the sticker (11) can be assigned to this UHF antenna, wherein the transponder is embodied as an RFID chip which is coupled to the UHF antenna.

17. The license plate (17, 19) as claimed in claim 13, wherein the transponder is an active or passive component.

18. The license plate (17, 19) as claimed in claim 13, wherein the protective cover is at least partially demetallized, at least in the area of the sticker (11) and/or in the area of a slot (20), or the protective cover is embodied as a prismatic film or as a PVC film or as a transparent plate, in particular made of PMMA or PC, or as some other type of film.

19. A device for equipping a license plate (17, 19), preferably a motor vehicle license plate, with at least one data carrier which can be read out in a contactless fashion and which is integrated into a sticker (11), in particular a label, with a plurality of successive workstations which are linked to at least one conveyor, and is designed to carry out a method for equipping the license plate (17, 19) with the at least one data carrier, wherein the at least one data carrier is secured to the license plate (17, 19), wherein the sticker (11), which has the at least one data carrier, is secured to the license plate body (16) or to the metal plate (10) in order to produce the multiplicity of license plate bodies (16).
